(19) United States
(12) Patent Application Publication
(10) Pub. No.: US 2025/0185538 A1
(43) Pub. Date: Jun. 12, 2025

(54) HEADER MONITORING SYSTEM

(71) Applicant: Deere & Company, Moline, IL (US)

(72) Inventors: RANA SHAKTI SINGH, RAMGARH (IN); NATHAN R. VANDIKE, GENESEO, IL (US); SCOTT N. CLARK, BETTENDORF, IA (US)

(21) Appl. No.: 18/534,924

(22) Filed: Dec. 11, 2023

(51) Int. Cl. A01D 41/127; A01B 69/04

(52) U.S. Cl. CPC A01D 41/1271; A01B 69/008

(57) ABSTRACT

Provided is an implement for an agricultural harvesting machine. The implement, having first and second ends, includes at least one sensor configured to provide information, such as an image, to a control system. Such an image may include information regarding one or more of a harvesting zone of the implement and a rear zone behind the implement. In some embodiments sensors may be located at one or both of said first and second ends and provide a view in the direction of the opposing end. Some embodiments may include one or more intermediate sensors located at a location between said first and second ends and configured to provide a view in the direction of an end. The sensors may be substantially in-line with a harvesting zone of the implement.

### TECHNICAL FIELD

The present disclosure relates generally to harvesters for agricultural harvesting. More particularly it relates to an invention for monitoring a front portion of the harvester, such as a combine harvester head, also called an implement or a header, and/or a zone behind the implement.

### BACKGROUND

Combines, or sometimes combine harvesters or harvesters, serve to harvest crop(s) at the end of an agricultural season. Combines are so named because they combine several tasks necessary to process a crop, such as a grain crop, at harvest. For example, a combine may cut, thresh, and clean the crop. A combine includes several subsystems, which may include, but are not limited to, a header or implement, a threshing section, a separating section, a cleaning shoe, a tailings section, a clean grain tank, and a residue handling section. Each of these subsystems may in turn include several components. A combine operator may operate the combine from an operator station, such as a cabin or cab. The operator is typically unable to see the operation of several of the combine components from their viewpoint in the cab, including but not limited to certain sections of the implement. Other harvesters include, but are not limited to, cotton harvesting devices such as cotton pickers and cotton strippers, hay and forage machinery such as forage harvesters and windrowers, and sugarcane harvesters.

### SUMMARY

According to an aspect of the present disclosure, provided is an implement for an agricultural harvesting machine. The implement includes first and second ends. Further included are at least one gathering portion, a control system, and one or more first end sensors. The one or more sensors are located at the first end and are configured to provide information to the control system regarding at least one of a harvesting zone and a rear zone. In some embodiments, the implement may also include at least one severing portion.

In some embodiments, the sensed information includes at least one of gathering portion information, severing portion information, crop information, and field information. In some embodiments, the sensors provide a first image to the control system. The image may include a view in the direction of the second end. The implement may also include one or more second end sensors configured to provide information to the control system. The second end sensor information may be an image that includes a view in the direction of the first end. The first and second end sensors may be in-line with the harvesting zone.

Some embodiments of the present invention may also include one or more intermediate sensors that provide sensed information, such as an image, to the control system. The image may include a view in the direction of at least one of the first and second ends. In some embodiments, first end sensors may be located on a first end sensor support. In some embodiments, intermediate sensors may be located on an intermediate sensor support. In some embodiments, the sensor(s) maybe be selected from the group consisting of long range terahertz radar, FMCW radar, micro radar, narrow band radar, UWB radar, ground penetrating radar, an ultra-sonic sensor, a thermal camera, a visible camera, a stereo camera, a structured light, LiDAR, a laser vibrometer, an infrared NMR camera, an infrared SWIR camera, an infrared terahertz sensor, a far infrared sensor, a sonar sensor, and combinations thereof.

In some embodiments, an implement for an agricultural harvesting machine is provided, the implement having first and second ends, a harvesting zone between the first and second ends, and at least one intermediate location extending between the first and second ends. The implement may further include at least one gathering portion and at least one severing portion located in the harvesting zone, a control system, and at least one sensor. The at least one sensor may be selected from the group consisting of at least one sensor at the first end configured to provide a first image in the direction of the second end, at least one sensor located at the second end configured to provide a second image in the direction of the first end, and at least one intermediate sensor configured to provide a third image in the direction of one or more of the first and second ends. The at least one sensor is configured to provide an image having a view of at least a portion of at least one of the agricultural zone and rear zone. Some embodiments may include sensors at all of the first end, second end, and at least one intermediate location. In some embodiments, the agricultural harvesting machine may be a combine harvester.

### BRIEF DESCRIPTION OF THE DRAWINGS

The detailed description of the drawings refers to the accompanying figures.

FIG. 1 is an elevation view showing the side of an exemplary combine harvester having a draper head.

FIG. 2 is an elevation view showing the front of an exemplary combine harvester having a corn head.

FIG. 3 is a perspective view of a first embodiment of an implement for an agricultural harvesting machine of the present invention.

FIG. 4 is a perspective view of a gathering portion and a severing portion of the first embodiment of an implement for an agricultural harvesting machine of FIG. 3.

FIG. 5 is a perspective view of a second embodiment of an implement for an agricultural harvesting machine of the present invention.

FIG. 6 is a perspective view of a gathering portion and a severing portion of the second embodiment of an implement for an agricultural harvesting machine of FIG. 5.

FIG. 7 is a plan view of an embodiment of an agricultural harvesting machine of the present invention looking down from above.

FIG. 8 is a block diagram of an example control system that may be used in embodiments of the present invention.

Like reference numerals are used to indicate like elements throughout the several figures.

### DETAILED DESCRIPTION

The following is a detailed description of one or more embodiments of technology, including systems, methods, and apparatuses, for providing information about an implement gathering portion and/or severing portion of an agricultural harvester.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Moreover, often terms such as “above,” “below,” “upward,” “downward,” “top,” “bottom,” etc., will also be used in connection with describing the combine harvester as it is oriented when it sits on the ground in its customary operating mode. However, these terms are again used for description purposes and do not represent limitations on the scope of the disclosure, unless required by the claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

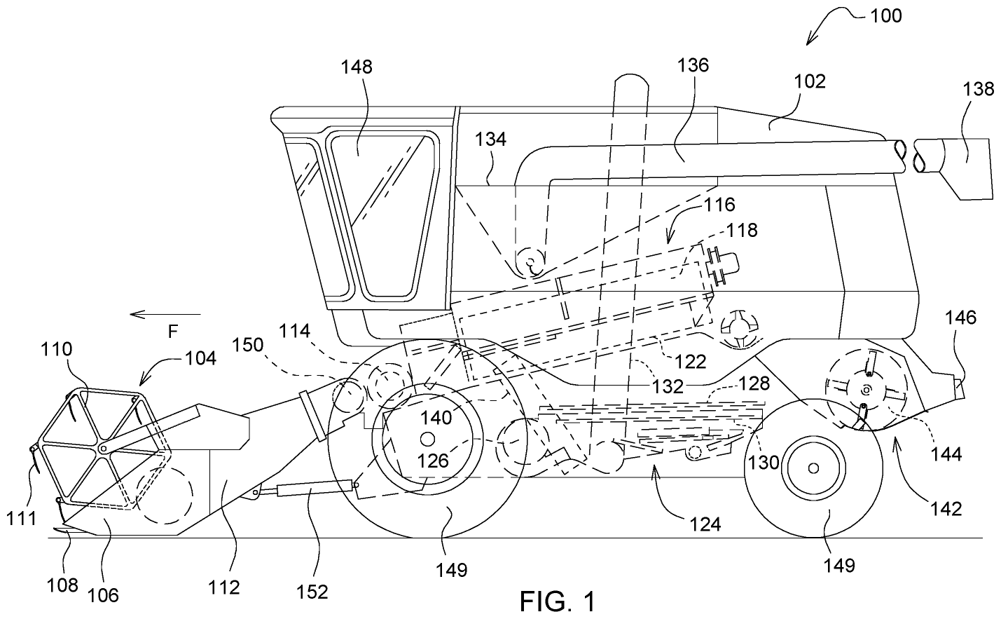

Referring to FIG. 1, an example of an agricultural harvester 100 (sometimes “harvester”) is shown. The illustrated harvester 100 serves to remove and process crop products, including but not limited to grains, from a field. In some embodiments, the agricultural harvester 100 is configured to move in a forward direction of travel F through a crop field to harvest plants, such as crops planted in rows. The illustrated agricultural harvester 100 is a combine harvester. As noted above, combine harvesters are so named because they combine two or more tasks associated with harvesting a crop. The illustrated harvester shows components associated with at least the following tasks: gathering crop, severing or cutting crop, threshing, separating crop products from crop residue, cleaning crop products, processing tailings, and processing crop residue. However, agricultural harvesters having fewer, more, and/or different functions are included in the scope of this invention.

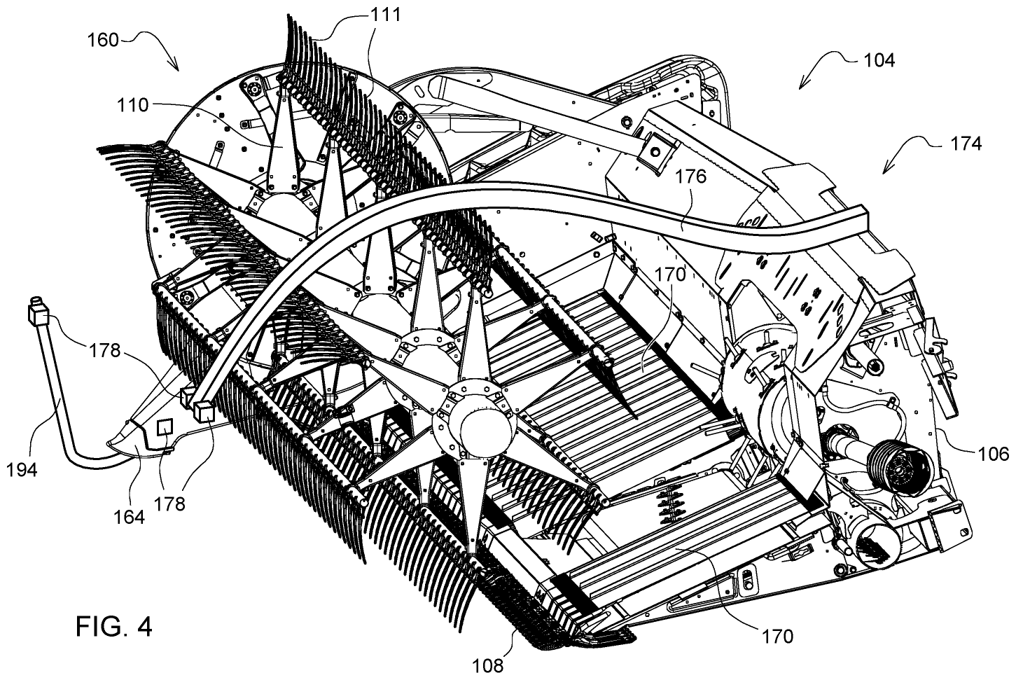

Referring to the gathering and severing functions, harvester 100 may include an implement 104 (sometimes called a head or header) to gather and/or cut crop, as well as transport the cut crop material to be processed toward a feeder house 112 for transport to the body 102 of the harvester 100. FIG. 1 illustrates a harvester 100 having a draper head 106, which is typically suited for harvesting crops such as small grains (e.g., wheat, barley), large grains (e.g., soybeans, peas, beans), grasses, and pulse crops (e.g., lentils). Other types of heads include, but are not limited to, a corn head (described below), auger, row head, belt pickup, row unit, and cutterhead. The draper head includes a cutter 108 and reel 110 which serve to sever and gather crops, respectively. The reel 110, illustrated as having a plurality of tines 111, engages the crop to be cut and gathers it toward the cutter 108. In the draper head of FIG. 1, the cutter 108 may include one or more knives or blades (as shown in FIG. 4). The cut portions of the crop may be moved towards a feeder house 112, which may be located near the center of the implement 104 (when viewed from the front). Movement towards the feeder house 112 may be via one or more conveyer belts, augers, or other means. The cut portions of the crop may be moved from the feeder house 112 to a feed accelerator 114 and into the body 102 of the combine 100. In the body 102 of the combine 100, the cut portions of the crop are first introduced to a threshing section or thresher 116. The threshing section 116 removes the grain (or other crop product) from the portion of the plant to which it is attached (e.g., the threshing section may separate one or more corn kernels from a cob or one or more soybeans from a pod). The remaining portion of the plant may be referred to as residue or crop residue. The threshing section 116 typically includes a rotor 118 with a plurality of threshing portions (not shown) extending therefrom. The rotor may be at least partially surrounded by one or more concaves (not shown). In some embodiments the concave(s) may be located generally underneath the rotor and include a grid that allows crop products, such as grain, to fall through to the cleaning section 124 while retaining larger pieces of cut crop material for processing through the residue handling section 142. A separating section 122 also separates grain from comparatively large pieces of crop residue.

The cleaning section 124, sometimes referred to as a cleaning shoe, may include a cleaning fan 126, chaffer 128, and a sieve 130 which work in combination to separate grain from comparatively similar sized pieces of crop residue that were not separated from the grain in the separating section 122. After the cleaning section 124, grain (or other crop products) may either be clean, in which case it follows the path of clean grain, or it may require further cleaning. If grain is clean, it moves to a clean grain elevator 132, which often takes the form of a belted conveyer, auger, or paddle conveyer, but may be any type. The clean grain elevator 132 moves clean grain to a clean grain tank 134. The clean grain may be moved from the clean grain tank 134 via an unloading auger 136 and spout 138. On the other hand, the grain may be incompletely threshed after moving through the cleaning section 124. Such grain is commonly referred to as tailings. The tailings may move to the tailings elevator 140, which often takes the form of a belted conveyer, auger, or paddle conveyer, but may be any type. The tailings elevator 140 may move the tailings back to the threshing section 116 to be further processed. Alternatively, in some harvesters 100 a separate tailings section (not shown) may further thresh and process the tailings. Crop residue may move through a residue handling section 142, which may include a chopper 144 and spreader 146. The residue handling section 142 ultimately discharges crop residue out of the harvester 100 via the spreader 146 back onto the field.

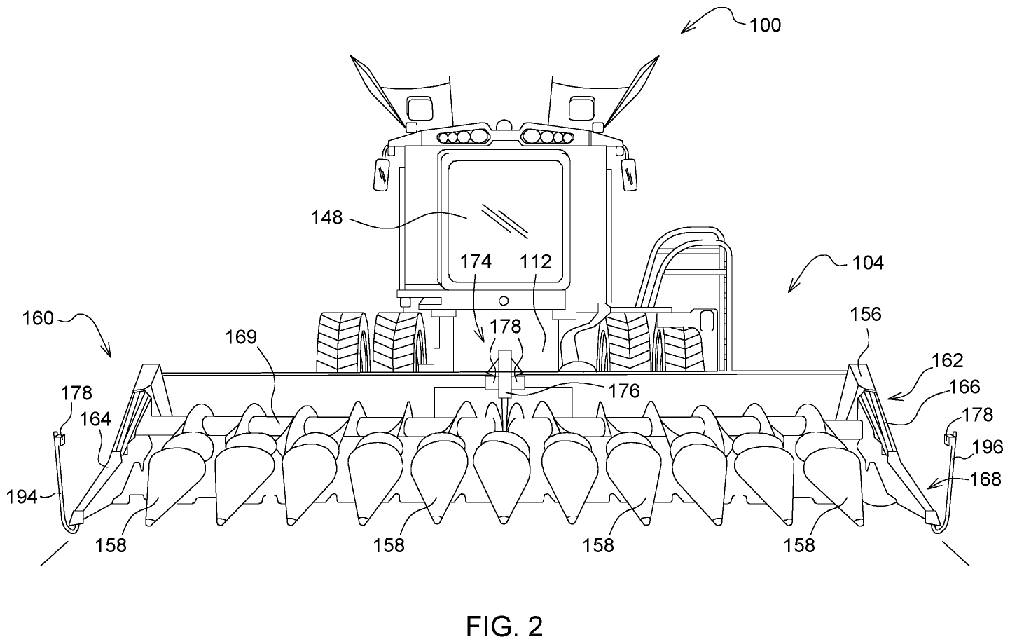

The harvester 100 components associated with gathering and severing crops and crop products are typically carried out by implement 104 and the components thereon. The remaining functions are typically housed in the body 102 of the harvester. The body 102 of the harvester may also include an operator station 148, engine (not shown), and ground engaging mechanism, such as one or more wheels 149 or one or more track assemblies (not shown). The harvester 100 may also include a control system, which may be housed in one or more locations and will be discussed in further detail below. Often, the control system may be accessed by an operator in the operator station 148. The implement 104 may be selectively removable from the body 102 of the harvester by any method known in the art now or in the future. The implement may be pivotable with respect to the combine body 102, such as at pivot 150. The pivoting movement may be aided by at least one implement support 152, which in the illustrated embodiment is a hydraulic support but may be of any type. To that end, implements, sometimes called headers or heads, may be interchangeable. Therefore, the same harvester 100 may be used to harvest a plurality of crops and crop products. For example, in FIG. 1, the harvester 100 includes a draper head 106. In other embodiments, such as that shown in FIG. 2, the harvester 100 is equipped with a corn head 156.

Referring to FIG. 2, the illustrated implement 104 includes a first end 160 and a second end 162. First and second end dividers 164, 166 may be located at the first and second ends. The end dividers 164, 166 divide crop to be harvested from crop that will not be harvested by the harvester 100 at a particular time. Similar to the draper head, the corn head 156 also carries out the functions of gathering and severing crop but is particularly adapted for picking row crops, such as corn plants. The corn head 156 may include one or more conical shaped dividers 158. The conical shaped dividers 158 work in cooperation with each other and/or the end dividers 164, 166 to direct or gather corn plants toward the cutter 168. Although illustrated as conical shaped, such dividers may take any shape, size, and/or form. In addition, the corn head 156 may include gathering chains (not shown) between the conical shaped dividers 158 to gather or direct the corn stalks to the cutter. In a corn head 156, the cutter 108 may take the form of two rollers working in combination to pinch and/or cut corn stalks, although any type of cutter may be used. The cutter 108 may also include deck plates (not shown). The rollers may pull the plant down, while the deck plates may displace ears of corn from the stalks. The cut portions of the crop (e.g., ears) may then be moved towards the feeder house 112, such as by one or more conveyer belts, augers, or other means, such as auger 169 shown in FIG. 2. Once at the feeder house 112, the cut portions of the crop move through the feed accelerator 114 and into the body 102 of the harvester 100. The cut portions of the crop are processed as described above in connection with FIG. 1, resulting in clean grain (or other crop products) and crop residue that is dispersed from the harvester 100 back onto the field.

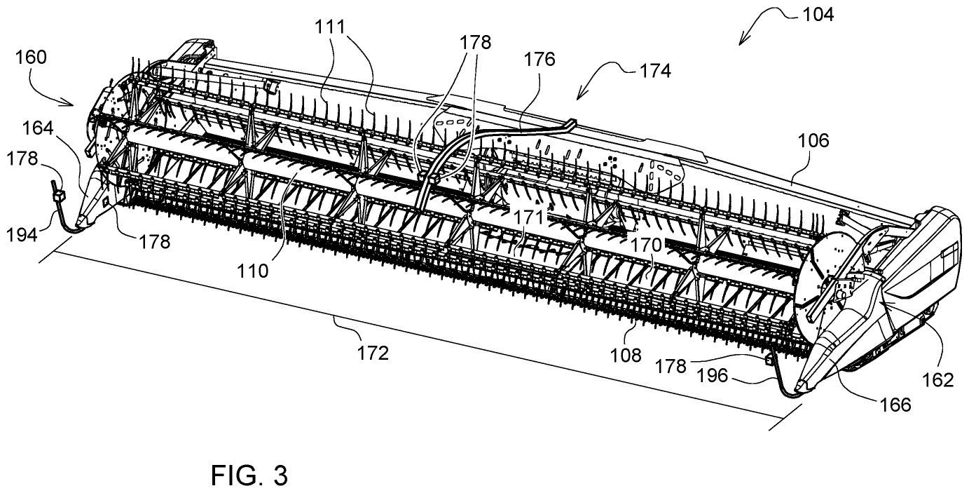

Turning to FIG. 3, an embodiment of an implement 104 of the present invention is shown. The implement is a draper head 106 having a reel 110, cutter 108, and conveyer. The illustrated conveyer includes one or more belts 170 that moves cut crop material away from the cutter 108 and towards the feeder house 112. Also present may be a center conveyer 171 that moves material from the one or more belts toward the feeder house 112. Further, the implement 104 includes a first end 160 and a second end 162. Located at the first and second ends 160, 162 are a first end divider 164 and a second end divider 166, respectively. The implement 104 may include a harvesting length 172 extending between the first end 160 and second end 162. The harvesting length 172 may be approximately the same length as the reel 110 and cutter 108. As noted above, the reel 100 gathers crop in the harvesting process, while the cutter 108 severs the crop in the harvesting process. The implement 104 may include at least one intermediate location 174 between the first and second ends 160, 162. The intermediate location(s) 174 may be any location(s) between the first and second ends 160, 162. In some embodiments, one intermediate location 174 may be near the center of the harvesting length 172. In some embodiments, intermediate locations may be at one or more reel arms. Reel arms are structures located on the header that support the reel 110. In some embodiments, one or more reel arms may be located near the center of the harvesting length 172.

The implement 104 may also include one or more sensors 178. The sensors 178 may be located at one or more of said first end 160, second end 162, and one or more intermediate locations 174. The sensors 178 may be configured to provide information to the control system, which will be described in more detail below. The information may regard at least one of the gathering and severing portions of the implement 104, e.g., the reel and/or cutter in the embodiment illustrated in FIG. 3, crop information about the crop subjected to the harvesting operation, and field information about the field over which the harvester 100 is traveling. The sensor(s) 178 may be any type known now or in the future. In some embodiments, the sensor(s) 178 may be radar including, but not limited to, long range terahertz radar, FMCW radar, micro radar, narrow band radar, UWB radar, ground penetrating radar; an ultra-sonic sensor; a thermal camera; a visible camera; a stereo camera; a structured light; LiDAR; a laser vibrometer; an infrared NMR camera; an infrared SWIR camera; an infrared terahertz/FIR sensor; a sonar sensor; or combinations thereof. Such sensor(s) 178 may provide an image to the control system.

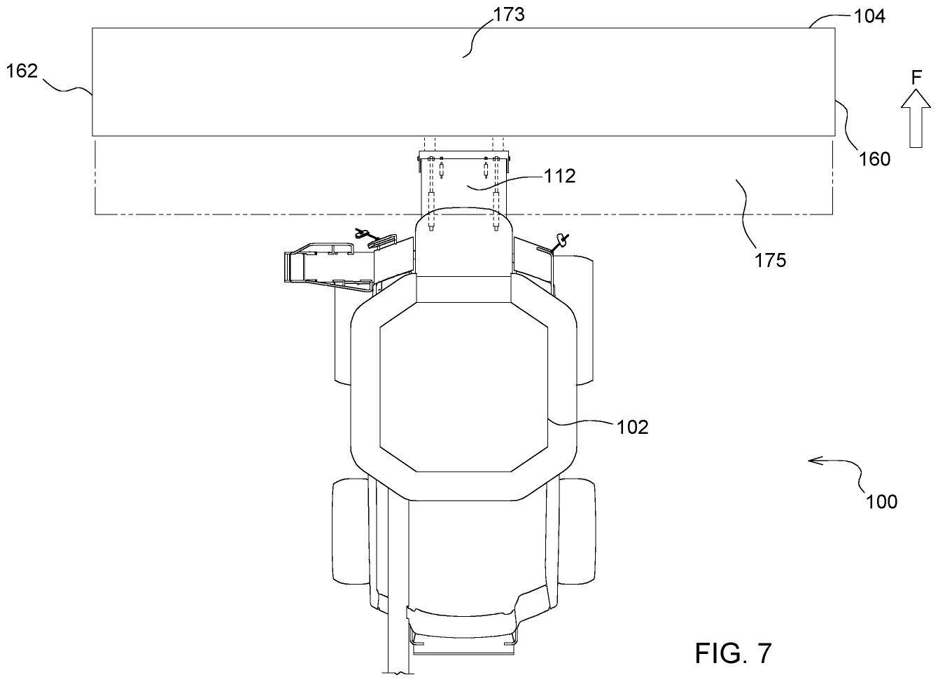

The sensors 178 may be configured to provide sensed information to the control system 180 regarding a harvesting zone 173 and/or a rear zone 175. Referring to FIG. 7, the harvesting zone 173 is the zone defined by the first end 160 and second end 162 on each side and the harvesting length 172 at the front and rear of the implement. The rear zone 175 is a zone extending behind the rear of the implement 104 with respect to the forward direction of travel F. Embodiments of a harvesting zone 173 and rear zone 175 are shown in FIG. 7.

In some embodiments, the sensors 178 are configured to view at least a portion of the harvesting zone 173 of the implement 104. In some embodiments, the sensors 178 are configured to view at least a portion of the rear zone 175 behind the implement 104. In some embodiments, the sensors 178 are in-line or approximately in-line with the harvesting zone 173 and/or provide a view aimed toward an end 160, 162 of the implement 104. For example, one or more sensor(s) 178 may be located at or near the first end 160 with a view toward the second end 162. The view may include all of the harvesting zone 173 and/or rear zone 175 or portions thereof. In another example, one or more sensor(s) 178 may be located at the second end 162 with a view toward the first end 160. The view may include all of the harvesting zone 173 and/or rear zone 175 or portions thereof. In yet another example, one or more sensor(s) 178 may be located at an intermediate location 174 and aimed with a view toward one or more of the first end 160 and second end 162. Such a view may include all or a portion of the harvesting zone 173 and/or all or a portion of the rear zone 175. In some embodiments, sensors 178 may be located at both the first end 160 and second end 162 aimed toward the opposite end and/or toward the rear zone 175. Moreover, in some embodiments, sensors 178 may be located at the first end 160, second end 162, and at one or more intermediate locations 174. Referring again to FIG. 3, the illustrated embodiment includes an intermediate sensor support 176. The intermediate sensor support 176 may be a structure that only supports one or more sensors, or it may be a structure with other purposes, such as a reel arm. Moreover, in the illustrated embodiment, a plurality of sensors 178 are located at the intermediate location 174, with at least one sensor providing a view toward the first end 160 and/or rear zone 175 and at least one sensor providing a view toward the second end 162 and/or rear zone 175.

As shown in FIG. 3, sensors 178 may be located at one or more positions on the ends 160, 162. In some embodiments, sensors may be located on end dividers 164, 166 looking across at least a portion of the harvesting zone 173. In some embodiments sensors 178 may be located on first end sensor support 194 and/or second end sensor support 196. The first and second end sensor supports 194, 196 may be supports that are present only for the purpose of supporting the sensors 178 or may be another structure at the first and second ends 160, 162 that serves one or more purposes in addition to supporting sensors 178. In some embodiments, a plurality of sensors may be located at one or both ends 160, 162 that are located on end dividers 164, 166, on end supports 194, 196, and/or on any other structure generally in proximity to the ends 160, 162. Sensors 178 located on end supports 194, 196, may have a view that is both toward the opposing end and also directed toward the cutter 108 and reel 110.

FIG. 4 is another view of a portion of the implement 104 of FIG. 3. Shown in FIG. 4 are the first end 160, cutter 108 and reel 110. Also shown are conveyers 170, such as conveyer belts, that move cut material in the direction of the feeder house 112 (not shown). As noted above, the reel 110 gathers crop toward the harvester 100, including the cutter 108, while the cutter 108 cuts the crops. Cut crop material moves to the conveyer 170. FIG. 4 also shows a plurality of sensors 178. Sensors 178 are shown at the first end 160, including on the first end divider 164 and a first end sensor support 194. These sensors may have a view looking towards the second end (shown in FIG. 3) and/or rear zone (shown in FIG. 7). In some embodiments, the sensor may also have a view that includes the cutter 108 and/or reel 110. Also shown in FIG. 4 is an intermediate support 176 which supports sensors 178 on a first side looking towards the first end 160 and/or rear zone and a second side looking towards the second end 162 and/or rear zone. In some embodiments, it may be desirable for these sensors to have a view that looks towards the cutter 108 and reel 110. Sensors 178 may also be located at the second end 162 in a similar fashion as shown with respect to the first end 160, including but not limited to on the second end divider 166, a second end sensor support 196, or in another location at the second end 162.

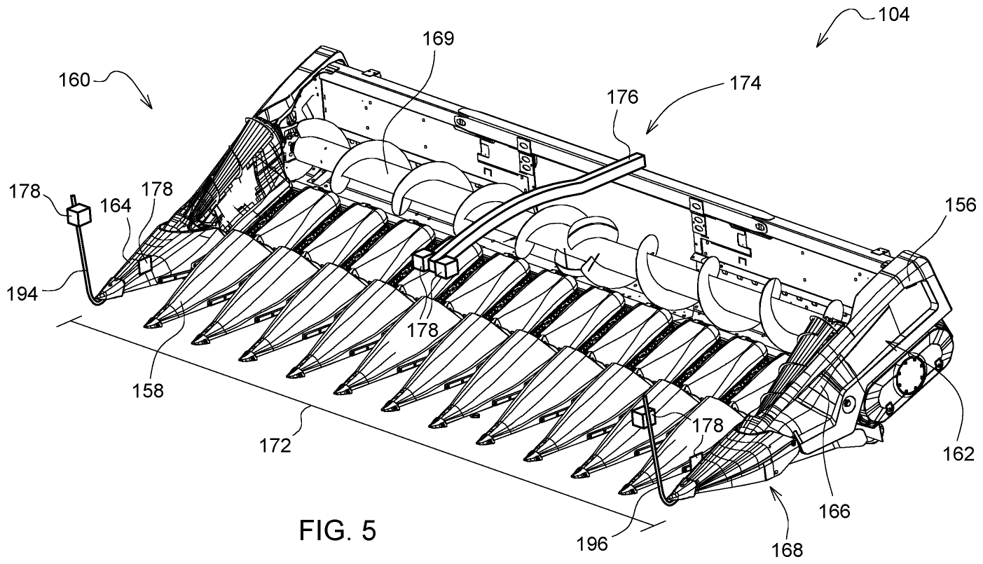

Turning to FIG. 5, a second embodiment of an implement 104 of the present invention is shown. In the embodiment of FIG. 5, the implement 104 is a corn head 156 having a first end 160 and a second end 162 with a harvesting length 172 extending therebetween. Also included are a gathering portion and a severing portion. The gathering portion may include a plurality of conical shaped dividers 158. The severing portion may include a plurality of pairs of rollers to sever corn stalks, as described above. The corn head 156 may also include an auger 169 or other conveying means to move cut crop towards the feeder house 112 (not shown in FIG. 5). Located at the first and second ends 160, 162 may be a first end divider 164 and a second end divider 166, respectively. The corn head 156 implement 104 may include at least one intermediate location 174 between the first and second ends 160, 162. In some embodiments, at least one intermediate location 174 may be near the center of the harvesting length 172, although any location between the first and second ends 160, 162 may be an intermediate location.

The embodiment illustrated in FIG. 5 may include one or more sensors 178. The sensors may be located at one or more of said first end 160, second end 162, and one or more intermediate locations 174. The sensors may be configured to provide information to the control system, which will be described in more detail below. The information may regard at least one of the gathering and severing portions of the implement, e.g., the conical shaped dividers 158 and/or the stalk rollers, crop information about a crop subjected to the harvesting operation, and/or field information about a field over which the harvest 100 is traveling. The sensor(s) 178 may be any type known now or in the future. In some embodiments, the sensor(s) 178 may be radar, including but not limited to long range terahertz radar, FMCW radar, micro radar, narrow band radar, UWB radar, ground penetrating radar; an ultra-sonic sensor; a thermal camera; a visible camera; a stereo camera; a structured light; LiDAR; a laser vibrometer; an infrared NMR camera; an infrared SWIR camera; an infrared terahertz/FIR sensor; a sonar sensor; or combinations thereof. The sensor 178 may provide an image.

In some embodiments, the sensors 178 are positioned so as to view at least a portion of the harvesting zone 173 of the implement 104 and/or a rear zone 175 behind the implement 104 relative to the forward direction of travel F (shown in FIG. 1). In some embodiments, the sensors 178 are in-line or approximately in-line with the harvesting zone 173 and/or provide a view aimed toward an end 160, 162 of the implement 104. For example, one or more sensor(s) 178 may be located at or near the first end 160 with a view toward the second end 162. The view may include all of the harvesting zone 173, rear zone 175, or portions thereof. In another example, one or more sensor(s) 178 may be located at the second end 162 with a view toward the first end 160. The view may include all of the harvesting zone 173, rear zone 175, or portions thereof. In yet another example, one or more sensor(s) 178 may be located at an intermediate location 174 and aimed with a view toward one or more of the first end 160 and second end 162. Such a view may include all or a portion of the harvesting zone 173 and/or rear zone 175. In some embodiments, sensors 178 may be located at both the first end 160 and second end 162 aimed toward the opposite end. Moreover, in some embodiments, sensors 178 may be located at the first end 160, second end 162, and at least one intermediate location 174. The illustrated embodiment includes an intermediate support 176. Moreover, in the illustrated embodiment, a plurality of sensors 178 are located at the intermediate location 174, with at least one sensor providing a view toward the first end 160 and at least one sensor providing a view toward the second end 162. An intermediate location 174 may also be conical shaped dividers 158. In some embodiments, the sensor may also have a view that looks towards the gathering portion and/or severing portion, e.g., the conical shaped dividers 158 and stalk rolls. This may include, but is not limited to, sensors 178 on the first end sensor support 194 or in positions on the first end divider 164 wherein the conical shaped dividers 158 and/or stalk rolls can be best seen with a view that looks back. In some embodiments, the intermediate location sensors 178 may be configured to provide a view that includes all or a portion of the rear zone 175. Also shown in FIG. 5 is an intermediate support 176 which supports sensors 178 on a first side looking towards the first end 160 and a second side looking towards the second end 162. In some embodiments, these sensors 178 may also have a view that looks towards the conical shaped dividers 158 and stalk rolls (or other cutter), and/or the rear zone 175.

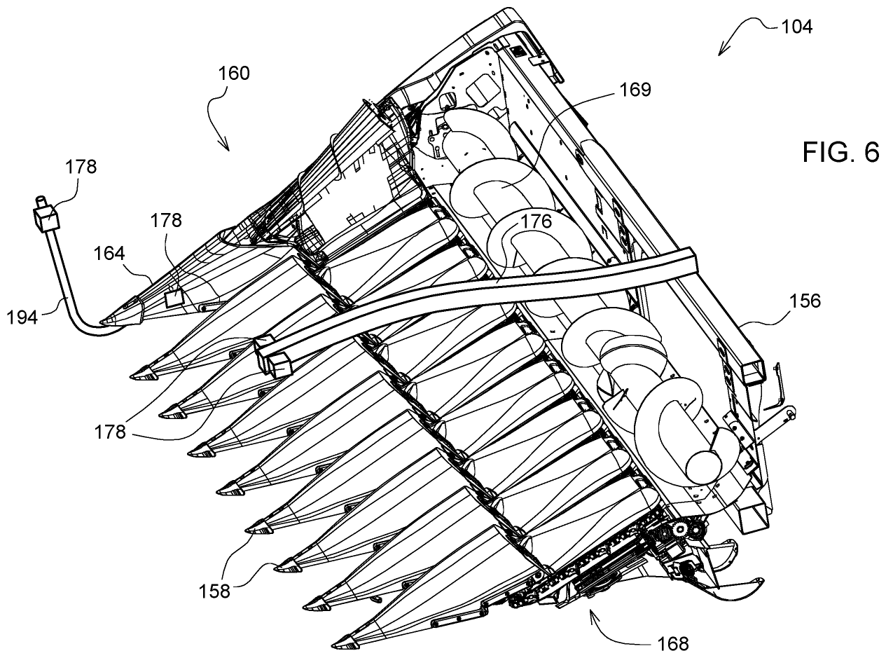

FIG. 6 is another view of the corn head 156 of FIG. 6. Shown in FIG. 6 is the first end 160, a plurality of conical shaped dividers 158, the first end divider 164, and the cutter 108. Also shown is a conveyer in the form of an auger 169 to move cut crop product toward the feeder house 112 (not shown). The corn head of FIG. 6 includes a plurality of sensors to view the gathering and severing portions, e.g. the conical shaped dividers 158 and cutter 108 which may be in the form of stalk rolls. The embodiment of FIG. 6 includes one or more sensors 178 on the first end divider 164. Also included is a first end sensor support 194 that includes one or more sensors. In addition, an intermediate support 176 includes one or more sensors 178. The sensor(s) 178 on the first end divider may provide a view towards the second end 162 (not shown in FIG. 6) and/or the rear zone 175 (not shown in FIG. 6). In some embodiments, the sensors 178 on the first end divider 164 are configured to provide a view that is directed towards the severing and cutting portions as needed to provide the desired view. In some embodiments, the sensor(s) 178 are configured to provide a view of the rear zone 175. In some embodiments, the sensor(s) 178 on the first end sensor support 194 are configured to provide a view towards the second end 162 The sensor(s) 178 on the intermediate support 176 may provide views toward one or more of the first end 160, second end 162 (not shown in FIG. 6), and/or rear zone 175 (not shown in FIG. 6). In some embodiments, the sensor(s) 178 on the intermediate support 176 may provide views of s the severing and cutting. In some non-illustrated embodiments, one or more sensor(s) may be located on one or more conical shaped dividers and/or any other structure providing a view of at least a portion of the agricultural zone 173. Sensor(s) 178 may also be located on the second 162 in a similar arrangement to those shown at the first end 160, including but not limited to on the second end divider 166, on a second end sensor support 196, or both.

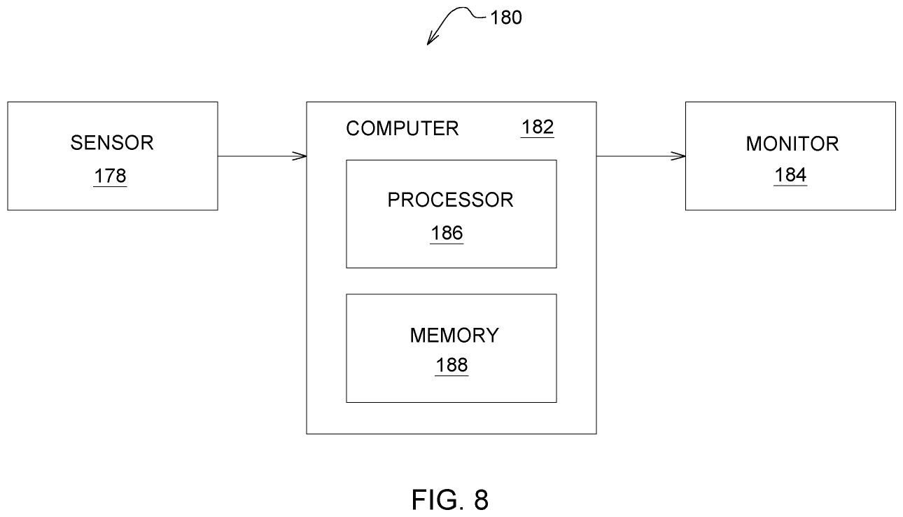

The sensor(s) 178 may provide information to a control system 180. FIG. 8 provides a block diagram of an example control system 180 to which one or more sensors 178 may provide information. The control system may include a computer 182. Such a computer 182 may be any type, including but not limited to a server, a desktop computer, a laptop/notebook computer, a wireless data port, a smart phone, a personal data assistant (PDA), a tablet computing device, or one or more processors within these devices, including physical instances, virtual instances, or both. Accordingly, the computer 182 may be an electronic computing device operable to receive, transmit, process, store, and manage data and information associated with the described subject matter, including but not limited to the information from the sensor(s) 178. The control system 180 may include input devices such as keypads, keyboards, and touch screens that can accept user information (not shown). Control system 180 may also include output devices that convey information associated with the operation of the control system 182 to an operator. Such conveyed information may include, but is not limited to, digital data, visual data, audio information, or a combination thereof. Moreover, such conveyed information may be presented in a graphical user interface on a monitor 184. The computer 182 may be communicatively coupled with a network (not shown). The computer 182 may include one or more processors 186. Generally, the one or more processors 186 may execute instructions and manipulate data to perform the operations of the computer 182. The computer 182 may also include at least one memory 188. The memory may hold data for the computer 182, including but not limited to instructions for the processor(s) 186 and/or information from the sensor(s) 178.

The sensor(s) 178 may be configured to provide information to the control system 180. The information may relate to one or more of the field, crop, harvester 100 performance, and the settings of the harvester 100. With respect to the field, the sensor(s) may provide information including but not limited to the status of one or more portions of the field. Such statuses may include, but are not limited to, whether a portion of the field was planted, has been harvested, and/or has not been harvested. With respect to the crop, the sensor(s) may provide information including but not limited to one or more of plant height, plant state (e.g., downed plant(s), standing, partially down, leaning, lodged, broken), plant health, plant population (e.g., number of plants, spacing of plants, uniformity of harvested crop), plant type (e.g., species, variety, hybrid), biomass yield (which may include yield of material other than grain (MOG)), plant mechanics (MOG toughness), plant moisture (e.g. grain moisture, stalk moisture, leaf moisture, etc.), grain yield, grain constituents (e.g., protein, starch), plant diameter (e.g. stalks, stems, total), EHP (ear, head, pod) height, EHP size, EHP mechanics (e.g., resistance to bending/breaking, firmness), pest damage, fungal damage, disease damage, presence of weeds, intensity of weed presence (e.g., size, pressure, amount), weed type, whether the crop is harvested or unharvested, and preharvest lost.

With respect to harvester 100 performance, the sensor(s) may provide information including but not limited to one or more of feedrate, stubble height, stubble uniformity (e.g., variance, flagging), uniformity and consistency of material flow (e.g., combine and front end equipment (FEE) material flow consistency, plugs), material flow at gathering portion and/or feeding (e.g., wrapping, carryover, tossing, pushing, bouncing), material flow at convergence, loss due to missed crop (e.g., crop that was never gathered or in control of the system, such as crop that is pushed over, lower than the header cut height, or due to flagging), grain capture, loss due to thrown crop (e.g., unthreshed crop that was engaged with the system but then lost), loss due to shattered grain (e.g., grain lost from the plant prior to being in control of front end equipment (FEE)), loss due to leaked grain (e.g., escaped grain that was once controlled by the system but then lost), material distribution (e.g., internal material distribution including but not limited to grain, MOG, chaff), resultant processed crop length (e.g., plant height less the stubble height), quality of the field condition (e.g., ruts, damage from field operation, piles of material, etc.), quality of harvester coverage (e.g., how well has the operation covered the area, was the operation straight, has there been operation overlap), and capacity in-operation (e.g., the in-operation actual capacity of the function of the harvester, such as machine throughput and header limits).

With respect to harvester 100 settings, the sensor(s) may provide information including but not limited to one or more of header point position (e.g., snout angle), header height, header orientation (e.g., lateral tilt, fore/aft tilt), auger/belt speed, reel height, reel fore/aft position, reel speed, reel finger timing, top auger position, top auger speed, end fender position, center feed section speed, feed drum/auger height, feed drum/auger finger timing, deck plate position, cutter bar fore/aft position.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined, connected) are to be construed broadly and may include intermediate members between a connection of elements and relative movement between elements. As such, joinder references do not necessarily infer that two elements are directly connected and in fixed relation to each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

1. An implement for an agricultural harvesting machine, said implement having first and second ends and a harvesting zone between said first and second ends, said implement configured to travel in a forward direction to harvest a crop, comprising:
at least one gathering portion located in said harvesting zone;
a control system; and
one or more sensors located at said first end and configured to provide sensed information to said control system regarding at least one zone selected from the group consisting of said harvesting zone and a rear zone opposite said forward direction.

2. The implement of claim 1, further comprising:
at least one severing portion located in said harvesting zone.

3. The implement of claim 2, wherein said sensed information includes at least one of gathering portion information, severing portion information, crop information, and field information about a field over which said agricultural harvesting machine is traveling.

4. The implement of claim 3, wherein said sensed information is one or more of gathering portion information and severing portion information.

5. The implement of claim 3, wherein said one or more sensors provide a first image to said control system.

6. The implement of claim 5, wherein said first image includes a view in the direction of said second end.

7. The implement of claim 3, further comprising one or more second end sensors configured to provide sensed information to said control system.

8. The implement of claim 7, wherein said second end sensors provide a second image to said control system.

9. The implement of claim 8, wherein said second image includes a view in the direction of said first end.

10. The implement of claim 7, wherein said first end sensors and said second end sensors are in-line with said harvesting zone.

11. The implement of claim 1, further comprising one or more intermediate sensors configured to provide sensed information to said control system.

12. The implement of claim 11, wherein said one or more intermediate sensors provide a third image to said control system wherein said third image includes a view in the direction of at least one said first and second ends.

13. The implement of claim 11, further comprising an intermediate sensor support and wherein said intermediate sensor is located on said intermediate sensor support.

14. The implement of claim 1, wherein said implement includes a first end sensor support and wherein said first end sensor is located on said first end support.

15. The implement of claim 1, wherein said one or more first end sensors are selected from the group consisting of long range terahertz radar, FMCW radar, micro radar, narrow band radar, UWB radar, ground penetrating radar, an ultra-sonic sensor, a thermal camera, a visible camera, a stereo camera, a structured light, LiDAR, a laser vibrometer, an infrared NMR camera, an infrared SWIR camera, an infrared terahertz sensor, a far infrared sensor, a sonar sensor, and combinations thereof.

16. An implement for an agricultural harvesting machine, said implement having first and second ends, a harvesting zone between said first and second ends, and at least one intermediate location between said first and second ends, comprising:
at least one gathering portion located in said harvesting zone;
at least one severing portion located in said harvesting zone;
a control system; and
at least one sensor configured to provide at least one image to said control system;
wherein said at least one sensor is selected from the group consisting of:
at least one sensor located at said first end configured to provide a first image in the direction of said second end, said first image providing a view in the direction of said second end of at least a portion of at least one of said harvesting zone and a rear zone opposite said forward direction;
at least one sensor located at said second end configured to provide a second image in the direction of said first end, said second image providing a view in the direction of said first end of at least a portion of at least one of said harvesting zone and said rear zone opposite said forward direction; and
at least one intermediate sensor located at said intermediate location configured to provide a third image, said third image providing a view in the direction of one or more of said first end and said second end of at least a portion of at least one of said harvesting zone and said rear zone opposite said forward direction.

17. The implement of claim 16, comprising:
said at least one sensor located at said first end;
said at least one sensor located at said second end;
said at least one intermediate sensor located at said intermediate location.

18. The implement of claim 17 wherein said agricultural harvesting machine is a combine harvester.
